(19) United States
(12) Patent Application Publication
(10) Pub. No.: US 2023/0155222 A1
(43) Pub. Date: May 18, 2023

(54) SECONDARY BATTERY AND METHOD OF MANUFACTURING SECONDARY BATTERY

(71) Applicant: MURATA MANUFACTURING CO., LTD., Kyoto (JP)

(72) Inventors: Takuya HORIE, Kyoto (JP); Manabu KOBARI, Kyoto (JP)

(21) Appl. No.: 18/098,884

(22) Filed: Jan. 19, 2023

Related U.S. Application Data
(63) Continuation of application No. PCT/JP2021/026630, filed on Jul. 15, 2021.

(30) Foreign Application Priority Data
Aug. 24, 2020 (JP) 2020-140625

(51) Int. Cl. H01M 50/184; H01M 50/105; H01M 50/186; H01M 10/0525

(52) U.S. Cl. CPC H01M 50/184; H01M 50/105; H01M 50/186; H01M 10/0525

(57) ABSTRACT

A secondary battery includes an outer package member and a battery device. The outer package member has flexibility. The battery device has an elongated shape and is contained inside the outer package member. The battery device includes a positive electrode and a negative electrode that are stacked on each other in a thickness direction of the battery device, with a separator interposed between the positive electrode and the negative electrode. The positive electrode and the negative electrode are each a sheet having a substantially rectangular shape. The battery device includes compression-bonding regions and a non-compression-bonding region other than the compression-bonding regions. The positive electrode, the negative electrode, and the separator are compression-bonded to each other in the compression-bonding regions that are provided at least at two respective positions opposed to each other in a peripheral edge part of the substantially rectangular shape.

### CROSS REFERENCE TO RELATED APPLICATIONS

The present application is a continuation of PCT patent application no. PCT/JP2021/026630, filed on Jul. 15, 2021, which claims priority to Japanese patent application no. JP2020-140625, filed on Aug. 24, 2020, the entire contents of which are being incorporated herein by reference.

The present technology relates to a secondary battery and a method of manufacturing a secondary battery.

Recently, a second battery of a stacked type has been proposed. The secondary battery of the stacked type includes, as a battery device, a stack in which a positive electrode and a negative electrode are stacked alternately with a separator interposed therebetween.

In the secondary battery of the stacked type, to suppress displacement of the separator, the positive electrode, and the negative electrode from each other in the stack, the separator, the positive electrode, and the negative electrode are fixed to each other by thermocompression-bonding. The stack of the separator, the positive electrode, and the negative electrode that are fixed to each other by thermocompression-bonding is placed in a pouch-shaped outer package member, is impregnated with an electrolytic solution, and is thereafter sealed in the pouch-shaped outer package member. The secondary battery is thus manufactured.

### SUMMARY

The present application relates to a secondary battery and a method of manufacturing a secondary battery.

In such a secondary battery of a stacked type, strong compression-bonding of a separator, a positive electrode, and a negative electrode can hinder the progress of degassing of an inside of a stack, which can hinder the progress of impregnation of the stack with an electrolytic solution. Accordingly, desired are a secondary battery and a method of manufacturing a secondary battery that each allow easier progress of the degassing of the inside of the stack.

Accordingly, it is desirable to provide a secondary battery and a method of manufacturing a secondary battery that each allow easier progress of degassing of an inside of a battery device upon sealing an outer package member.

A secondary battery according to an embodiment includes an outer package member and a battery device. The outer package member has flexibility. The battery device has an elongated shape and is contained inside the outer package member. The battery device includes a positive electrode and a negative electrode that are stacked on each other in a thickness direction of the battery device, with a separator interposed between the positive electrode and the negative electrode. The positive electrode and the negative electrode are each a sheet having a substantially rectangular shape. The battery device includes compression-bonding regions and a non-compression-bonding region other than the compression-bonding regions. The positive electrode, the negative electrode, and the separator are compression-bonded to each other in the compression-bonding regions that are provided at least at two respective positions opposed to each other in a peripheral edge part of the substantially rectangular shape.

A method of manufacturing a secondary battery according to an embodiment includes: forming a battery device having an elongated shape, by stacking a positive electrode and a negative electrode on each other with a separator interposed therebetween, the positive electrode and the negative electrode each being a sheet having a substantially rectangular shape; compression-bonding the positive electrode, the negative electrode, and the separator to each other in compression-bonding regions to thereby allow the battery device to include the compression-bonding regions and a non-compression-bonding region other than the compression-bonding regions, the compression-bonding regions being provided at least at two respective positions opposed to each other in a peripheral edge part of the substantially rectangular shape of the battery device; placing the battery device inside an outer package member and partly sealing the outer package member to leave an opening to thereby provide the outer package member with a pouch shape, the outer package member having flexibility; injecting an electrolytic solution into the outer package member through the opening; and sealing the opening.

According to an embodiment, the battery device includes the positive electrode that is the sheet having the substantially rectangular shape and the negative electrode that is the sheet having the substantially rectangular shape are stacked on each other in the thickness direction with the separator interposed therebetween. In such a battery device, the positive electrode, the negative electrode, and the separator are able to be compression-bonded to each other in the compression-bonding regions that are provided at least at the two respective positions opposed to each other in the peripheral edge part of the substantially rectangular shape. Accordingly, in the secondary battery according to an embodiment, it is possible to more easily perform degassing through the non-compression-bonding region other than the compression-bonding regions of the battery device upon sealing the outer package member.

Note that effects of the present technology are not necessarily limited to those described herein and may include any of a series of suitable effects in relation to the present technology.

### BRIEF DESCRIPTION OF THE FIGURES

FIG. 1 is a perspective diagram for describing a configuration of a secondary battery according to an embodiment of the present technology before sealing.

FIG. 2 is a perspective diagram for describing the configuration of the secondary battery according to an embodiment during the sealing.

FIG. 3 is a plan diagram for describing a configuration of a positive electrode.

FIG. 4 is a plan diagram for describing a configuration of a negative electrode.

FIG. 5 is a flowchart illustrating a flow of a method of manufacturing the secondary battery according to an embodiment.

FIG. 6 is a plan diagram illustrating a configuration example of a battery device of the secondary battery according to an embodiment.

FIG. 7 is a plan diagram for describing sizes of compression-bonding regions and a non-compression-bonding region.

FIG. 8 is a plan diagram illustrating another configuration example of the battery device of the secondary battery according to an embodiment.

FIG. 9 is a plan diagram illustrating still another configuration example of the battery device of the secondary battery according to an embodiment.

FIG. 10 is a block diagram illustrating a configuration of a battery pack which is an application example of the secondary battery according to an embodiment.

FIG. 11A is an explanatory diagram illustrating positions to provide the compression-bonding regions in a battery device of Example 1.

FIG. 11B is an explanatory diagram illustrating positions to provide the compression-bonding regions in a battery device of Example 2.

FIG. 11C is an explanatory diagram illustrating positions to provide the compression-bonding regions in a battery device of Example 3.

FIG. 11D is an explanatory diagram illustrating positions to provide the compression-bonding regions in a battery device of Example 4.

FIG. 12A is a heatmap representing a result of an ultrasonic inspection performed on the battery device of Example 1.

FIG. 12B is a heatmap representing a result of an ultrasonic inspection performed on the battery device of Example 2.

FIG. 12C is a heatmap representing a result of an ultrasonic inspection performed on the battery device of Example 3.

FIG. 12D is a heatmap representing a result of an ultrasonic inspection performed on the battery device of Example 4.

### DETAILED DESCRIPTION

One or more embodiments of the present technology are described below in further detail including with reference to the drawings.

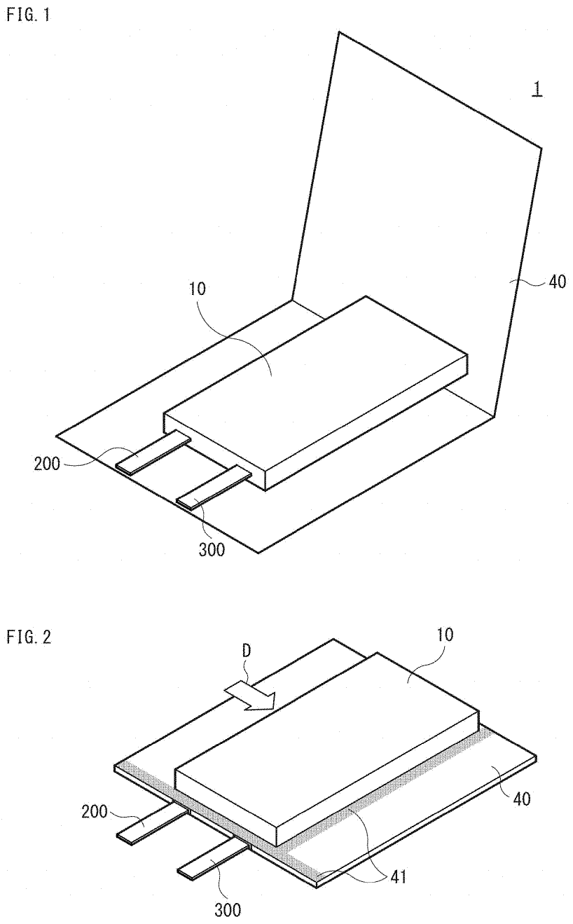

Referring to FIGS. 1 to 4, a description is given first of a secondary battery according to an embodiment.

The secondary battery to be described here is a secondary battery that obtains a battery capacity using insertion and extraction of an electrode reactant, and includes a positive electrode, a negative electrode, and an electrolytic solution. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited, the electrode reactant is a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is a so-called lithium-ion secondary battery. In the lithium-ion secondary battery, lithium is inserted and extracted in an ionic state.

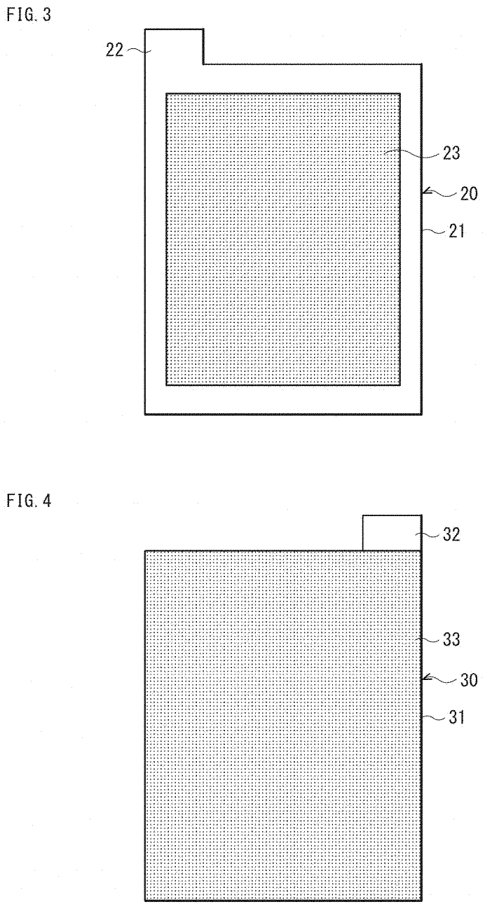

FIG. 1 is a perspective diagram for describing a configuration of a secondary battery 1 according to an embodiment before sealing. FIG. 2 is a perspective diagram for describing the configuration of the secondary battery 1 according to an embodiment during the sealing. FIG. 3 is a plan diagram for describing a configuration of a positive electrode 20. FIG. 4 is a plan diagram for describing a configuration of a negative electrode 30.

As illustrated in FIGS. 1 and 2, the secondary battery 1 includes an outer package member 40, a battery device 10, a positive electrode wiring line 200, and a negative electrode wiring line 300. The secondary battery 1 according to an embodiment includes a laminated film as the outer package member 40 for containing the battery device 10.

In the secondary battery 1, the battery device 10 is contained inside the outer package member 40, and the positive electrode wiring line 200 and the negative electrode wiring line 300 are coupled to the battery device 10.

Specifically, the outer package member 40 having a sheet shape is folded with the battery device 10 being placed substantially in the middle thereof. Fusion-bonding is performed at an outer periphery of the battery device 10 and the battery device 10 is thereby contained inside the outer package member 40. Electric coupling from an outside to the battery device 10 is established by each of the positive electrode wiring line 200 and the negative electrode wiring line 300 that extend from an inside toward an outside of the outer package member 40.

The outer package member 40 is a sheet-shaped member having flexibility or softness. The outer package member 40 includes one or more materials among, for example, polymer materials and metal materials.

Specifically, the outer package member 40 is a three-layered laminated film including a fusion-bonding layer, a metal layer, and a surface protective layer that are stacked in this order from an inner side. The fusion-bonding layer is a polymer film including a polymer material, such as polypropylene, that is fusion-bondable by a method such as a thermal-fusion-bonding method. The metal layer is a metal foil including a metal material such as aluminum. The surface protective layer is a polymer film including a polymer material such as nylon. The outer package member 40 which is a laminated film is not particularly limited in the number of layers. Instead of including three layers as described above, the outer package member 40 may be single-layered or two-layered, or may include four or more layers.

The outer package member 40 after sealing the battery device 10 therein has an opening for the positive electrode wiring line 200 to protrude therefrom and an opening for the negative electrode wiring line 300 to protrude therefrom. The opening for the positive electrode wiring line 200 to protrude therefrom and the opening for the negative electrode wiring line 300 to protrude therefrom are each sealed with a sealant.

The battery device 10 is a device that allows charging and discharge reactions to proceed and is contained inside the outer package member 40. Although it is not illustrated, the battery device 10 includes a stack impregnated with an electrolytic solution. The stack includes a sheet-shaped positive electrode and a sheet-shaped negative electrode that are stacked alternately with a separator interposed therebetween.

As illustrated in FIGS. 3 and 4, the positive electrode 20 and the negative electrode 30 are electrodes included in the battery device 10, and each have a rectangular sheet shape.

As illustrated in FIG. 3, the positive electrode 20 includes a positive electrode current collector 21, a positive electrode active material layer 23, and a positive electrode tab 22. The positive electrode active material layer 23 is provided on one side or each of both sides of the positive electrode current collector 21. The positive electrode tab 22 is bonded to an end part of the positive electrode current collector 21.

The positive electrode current collector 21 is a metal foil that includes a metal material such as aluminum. The positive electrode active material layer 23 includes a positive electrode active material into which lithium is insertable and from which lithium is extractable. The positive electrode active material includes one or more of lithium-containing compounds. Examples of the lithium-containing compound include a lithium-containing transition metal compound. Examples of the lithium-containing transition metal compound include an oxide, a phosphoric acid compound, a silicic acid compound, and a boric acid compound each including lithium and one or more transition metal elements as constituent elements. The positive electrode active material layer 23 may further include, for example, a positive electrode binder and a positive electrode conductor. The positive electrode tab 22 may include a metal material that is the same as the metal material included in the positive electrode current collector 21, or may include a metal material that is different from the metal material included in the positive electrode current collector 21. Specifically, the positive electrode tab 22 includes a metal material such as aluminum as with the positive electrode current collector 21. One end of the positive electrode tab 22 is coupled to the positive electrode current collector 21 and another end of the positive electrode tab 22 is coupled to the positive electrode wiring line 200.

As illustrated in FIG. 4, the negative electrode 30 includes a negative electrode current collector 31, a negative electrode active material layer 33, and a negative electrode tab 32. The negative electrode active material layer 33 is provided on one side or each of both sides of the negative electrode current collector 31. The negative electrode tab 32 is bonded to an end part of the negative electrode current collector 31.

The negative electrode current collector 31 is a metal foil that includes a metal material such as copper. The negative electrode active material layer 33 includes a negative electrode active material into which lithium is insertable and from which lithium is extractable. The negative electrode active material includes one or more materials among, for example, carbon materials and metal-based materials. Examples of the carbon material include graphite. The metal-based material is a material that includes, as a constituent element or constituent elements, one or more elements among metal elements and metalloid elements that are each able to form an alloy with lithium. Specifically, the metal-based material includes, for example, silicon and tin. The metal-based material may be a simple substance, an alloy, a compound, or a mixture of two or more thereof. The negative electrode active material layer 33 may further include, for example, a negative electrode binder and a negative electrode conductor. The negative electrode tab 32 may include a metal material that is the same as the metal material included in the negative electrode current collector 31, or may include a metal material that is different from the metal material included in the negative electrode current collector 31. Specifically, the negative electrode tab 32 includes a metal material such as copper as with the negative electrode current collector 31. One end of the negative electrode tab 32 is coupled to the negative electrode current collector 31 and another end of the negative electrode tab 32 is coupled to the negative electrode wiring line 300.

Note that an area of the positive electrode active material layer 23 provided on the positive electrode current collector 21 is less than an area of the negative electrode active material layer 33 provided on the negative electrode current collector 31. This is to make a charge capacity of the negative electrode 30 greater than a discharge capacity of the positive electrode 20, thereby preventing precipitation of lithium on a surface of the negative electrode 30 upon charging and discharging and thereby preventing a short circuit between the positive electrode 20 and the negative electrode 30. Specifically, the positive electrode active material layer 23 may be provided in a middle region of the positive electrode current collector 21 other than a peripheral edge part thereof, and the negative electrode active material layer 33 may expand over the entire surface of the negative electrode current collector 31.

The separator (unillustrated) is an insulating porous film interposed between the positive electrode 20 and the negative electrode 30. The separator prevents a short circuit between the positive electrode 20 and the negative electrode 30 and allows lithium to pass therethrough. The separator includes one or more of polymer compounds including, without limitation, polyethylene.

The positive electrode 20, the negative electrode 30, and the separator are each impregnated with the electrolytic solution. The electrolytic solution includes a solvent and an electrolyte salt. The solvent includes one or more of non-aqueous solvents (organic solvents) including, without limitation, a carbonic-acid-ester-based compound, a carboxylic-acid-ester-based compound, and a lactone-based compound. The electrolyte salt includes one or more of light metal salts including, without limitation, a lithium salt.

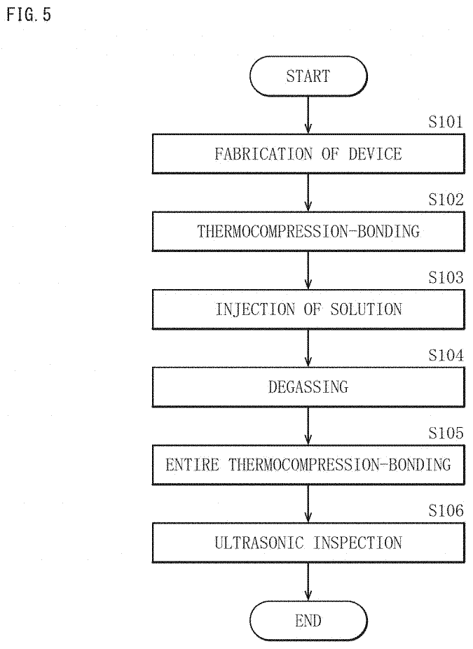

Next, referring to FIGS. 1, 2, and 5, a description is given of a method of manufacturing the secondary battery 1 according to an embodiment. FIG. 5 is a flowchart illustrating a flow of the method of manufacturing the secondary battery 1 according to an embodiment.

As illustrated in FIG. 5, first, the battery device 10 is fabricated (S101). Specifically, the positive electrode 20 and the negative electrode 30 are fabricated. Thereafter, the positive electrode 20 and the negative electrode 30 are stacked alternately with the separator interposed therebetween, and the positive electrode 20, the negative electrode 30, and the separator are fixed to each other by thermocompression-bonding. Thus, the battery device 10 of the stacked type is fabricated.

Specifically, the positive electrode 20 and the negative electrode 30 can be fabricated by the following method according to an embodiment.

Specifically, first, the positive electrode active material is mixed with other materials including, without limitation, the positive electrode binder and the positive electrode conductor on an as-needed basis to thereby prepare a positive electrode mixture. Thereafter, the positive electrode mixture is put into a solvent such as an organic solvent to thereby prepare a paste positive electrode mixture slurry. Thereafter, the positive electrode mixture slurry is applied on both sides of the positive electrode current collector 21 to thereby form the positive electrode active material layers 23. Thereafter, the positive electrode active material layers 23 are compression-molded by means of, for example, a roll pressing machine. It is thus possible to fabricate the positive electrode 20 in which the positive electrode active material layer 23 is provided on each of both sides of the positive electrode current collector 21. Note that the positive electrode active material layers 23 may be heated. The positive electrode active material layers 23 may be compression-molded multiple times.

In addition, the negative electrode active material is mixed with other materials including, without limitation, the negative electrode binder and the negative electrode conductor on an as-needed basis to thereby prepare a negative electrode mixture. Thereafter, the negative electrode mixture is put into a solvent such as an organic solvent to thereby prepare a paste negative electrode mixture slurry. Thereafter, the negative electrode mixture slurry is applied on both sides of the negative electrode current collector 31 to thereby form the negative electrode active material layers 33. It is thus possible to fabricate the negative electrode 30 in which the negative electrode active material layer 33 is provided on each of both sides of the negative electrode current collector 31. Note that the negative electrode active material layers 33 may be compression-molded.

Thereafter, the fabricated battery device 10 is sandwiched by the outer package member 40 having the sheet shape, and fusion-bonding is performed by thermocompression-bonding on sealing parts 41 (S102). The sealing parts 41 correspond to two sides at the outer periphery of the battery device 10, as illustrated in FIG. 2. This makes the outer package member 40 into a pouch-shaped structure in which the battery device 10 is containable.

Note that thermocompression-bonding may be performed on the outer package member 40 to make the outer package member 40 into a pouch-shaped structure having an opening on a lateral side D that is different from a side where the positive electrode wiring line 200 and the negative electrode wiring line 300 protrude from the battery device 10. The fusion-bonding area tends to be small on the side where the positive electrode wiring line 200 and the negative electrode wiring line 300 protrude. In view of this, on the side where the positive electrode wiring line 200 and the negative electrode wiring line 300 protrude, thermocompression-bonding is preferably performed in advance before the electrolytic solution is injected into the outer package member 40. This prevents, in the secondary battery 1, application of a high inner pressure on the side where the positive electrode wiring line 200 and the negative electrode wiring line 300 protrude when the outer package member 40 is sealed after the electrolytic solution is injected into the outer package member 40.

Thereafter, the electrolytic solution is injected into the outer package member 40 having the pouch-shaped structure from the lateral side D (S103) to thereby impregnate the battery device 10 with the electrolytic solution. The electrolytic solution is preparable by putting the electrolyte salt into the solvent and dispersing or dissolving the electrolyte salt in the solvent.

Thereafter, the outer package member 40 with the injected electrolytic solution is left in a vacuum and reduced pressure environment to thereby degas the battery device 10 impregnated with the electrolytic solution (S104).

Thereafter, fusion-bonding is performed by thermocompression-bonding on the entire outer periphery of the outer package member 40 including the lateral side D on which the opening of the outer package member 40 is present (S105). Thus, it is possible to completely seal the battery device 10 in the outer package member 40.

Further, after the elapse of a period of time that allows the battery device 10 to be sufficiently impregnated with the electrolytic solution, a pass/fail determination is made on the fabricated secondary battery 1 by ultrasonic inspection (S106).

By the above-described processes, it is possible to fabricate the secondary battery 1 according to an embodiment.

As described above, in the battery device 10 of the stacked type, fixing the positive electrode 20, the negative electrode 30, and the separator to each other by thermocompression-bonding prevents displacement of the positive electrode 20, the negative electrode 30, and the separator from each other in a later process. However, an increase in the region in which the positive electrode 20, the negative electrode 30, and the separator are fixed to each other by thermocompression-bonding in the battery device 10 makes it more difficult to degas the inside of the battery device 10. If gas remains in the battery device 10 after the outer package member 40 is sealed, a battery characteristic of the secondary battery 1 is degraded. Therefore, it is important to surely degas the battery device 10 while suppressing displacement of the positive electrode 20, the negative electrode 30, and the separator from each other in the battery device 10.

The secondary battery 1 according to an embodiment is made in view of the above-described issue. In the secondary battery 1 according to an embodiment, the positive electrode 20, the negative electrode 30, and the separator are compression-bonded to each other in a particular region in the battery device 10 of the stacked type. In the secondary battery 1 according to an embodiment, it is therefore possible to achieve both fixing of the positive electrode 20, the negative electrode 30, and the separator and easy degassing of the battery device 10. In the following, such technical features of the secondary battery 1 according to an embodiment are described in detail.

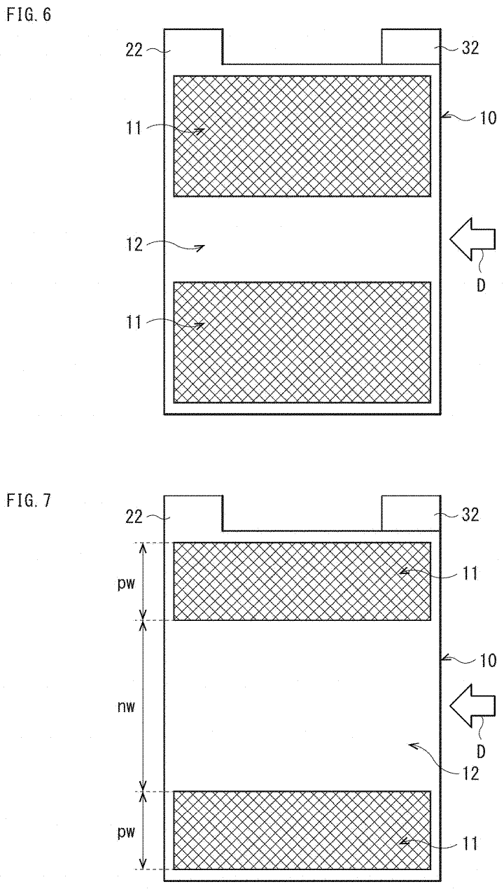

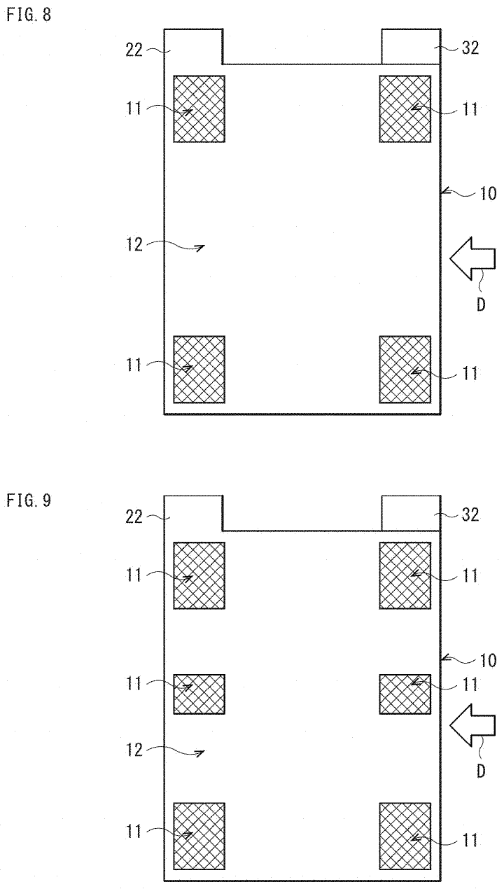

Next, referring to FIGS. 6 to 9, a description is given of the technical features of the secondary battery 1 according to an embodiment. FIG. 6 is a plan diagram illustrating a configuration example of the battery device 10 of the secondary battery 1 according to an embodiment. FIG. 7 is a plan diagram for describing sizes of compression-bonding regions 11 and a non-compression-bonding region 12. FIGS. 8 and 9 are plan diagrams each illustrating another configuration example of the battery device 10 of the secondary battery 1 according to an embodiment.

Reference is made to FIG. 6. The battery device 10 of the stacked type includes the positive electrode 20 and the negative electrode 30 that are stacked on each other with the separator interposed therebetween. The positive electrode 20 and the negative electrode 30 each have a substantially rectangular shape. The compression-bonding regions 11 are provided at two respective positions opposed to each other in a peripheral edge part of the substantially rectangular shape. Thermocompression-bonding is performed on the battery device 10 in the compression-bonding regions 11. A region, of the battery device 10 having a rectangular shape, other than the compression-bonding regions 11 is the non-compression-bonding region 12 in which the thermocompression-bonding is not performed. The compression-bonding regions 11 are each confirmed as a pressure mark that is a depression part depressed relative to the non-compression-bonding region 12 by 1 μm to 20 μm in the thickness direction of the battery device 10.

Thus, in the battery device 10, it is possible to fix the stacked positive electrode 20, negative electrode 30, and separator to each other at least at two points in the peripheral edge part of the substantially rectangular shape. Accordingly, it is possible to prevent displacement of the positive electrode 20, the negative electrode 30, and the separator. In addition, it is possible to provide, in the peripheral edge part of the substantially rectangular shape of the battery device 10, the non-compression-bonding region 12 in which thermocompression-bonding is not performed and that allows gas to easily flow therethrough. Accordingly, it is possible to degas the inside of the battery device 10 though the non-compression-bonding region 12.

Specifically, in a case where the electrolytic solution is injected from the lateral side D of the substantially rectangular shape of the battery device 10 and the inside of the battery device 10 is degassed from the lateral side D in a fabrication process of the secondary battery 1, the compression-bonding region 11 may be provided, in a band shape, at each of an upper end side and a lower end side of the substantially rectangular shape of the battery device 10 provided with the positive electrode tab 22 and the negative electrode tab 32. The lower end side is the opposite side to the upper end side of the substantially rectangular shape of the battery device 10. Thus, the battery device 10 is fixed at the respective compression-bonding regions 11 provided at an upper end part and a lower end part. In addition, it is possible to provide the battery device 10 with the non-compression-bonding region 12 facing the lateral side D in a degassing direction, allowing gas to easily flow from an inside to an outside through the non-compression-bonding region 12.

More specifically, the compression-bonding regions 11 may be provided in an island form to allow the non-compression-bonding region 12 to be present at a side, of the substantially rectangular shape, that faces the lateral side D from which the electrolytic solution is injected into the outer package member 40 having the pouch-shaped structure and from which the battery device 10 is degassed. Thus, it is possible to provide the battery device 10 with the non-compression-bonding region 12 as a degassing path that allows gas to easily flow through from the middle part of the battery device 10 to the lateral side D from which the battery device 10 is degassed. Accordingly, it is possible to more easily perform degassing.

Note that, on the lateral side D from which the battery device 10 is degassed, thermocompression-bonding is performed on the outer package member 40 after the electrolytic solution is injected into the outer package member 40. As a result, the sealing part 41 of the outer package member 40 on the lateral side D includes the electrolytic solution. Accordingly, in the secondary battery 1, it is possible to determine the lateral side D from which the electrolytic solution is injected into the outer package member 40 and from which the battery device 10 is degassed, on the basis of whether the sealing part 41 fusion-bonded by the thermocompression-bonding includes the electrolytic solution.

In addition, as illustrated in FIG. 7, it is preferable that, at one side of the substantially rectangular shape of the battery device 10, the sum total of widths pw of the respective compression-bonding regions 11 be less than a width nw of the non-compression-bonding region 12. By making the width nw of the non-compression-bonding region 12 which allows gas to easily flow through greater than the widths pw of the compression-bonding regions 11 in the battery device 10, it is possible to more easily perform degassing. Although it is preferable that the widths pw of the compression-bonding regions 11 be less than the width nm of the non-compression-bonding region 12 at least at one side of the substantially rectangular shape of the battery device 10, it is more preferable that the widths pw of the compression-bonding regions 11 be less than the width nw of the non-compression-bonding region 12 at one side on the lateral side D from which the battery device 10 is degassed.

It is still more preferable that the sum total of the widths pw of the respective compression-bonding regions 11 be less than or equal to 65% of a length of the one side of the substantially rectangular shape of the battery device 10. In other words, it is still more preferable that the width nw of the non-compression-bonding region 12 be greater than or equal to 35% of the length of the one side of the substantially rectangular shape of the battery device 10. In such a case, as will be described later with reference to Examples, it is possible to sufficiently degas the battery device 10 and to thereby reduce gas remaining inside the battery device 10. Accordingly, in the secondary battery 1, it is possible to suppress generation of a void where no electrolytic solution is impregnated in the battery device 10. As a result, it is possible to suppress degradation of a battery characteristic of the secondary battery 1.

In the secondary battery 1 according to an embodiment, the positions to provide the respective compression-bonding regions 11 in the battery device 10 are not limited to those illustrated in FIG. 6 as an example. As illustrated in FIGS. 8 and 9, the compression-bonding regions 11 may be provided at other positions in the substantially rectangular shape of the battery device 10.

As illustrated in FIG. 8, the compression-bonding regions 11 may be provided at respective four corners of the substantially rectangular shape of the secondary battery 1 in an island form. Thus, in the battery device 10, the compression-bonding regions 11 and the non-compression-bonding region 12 that allows gas to easily flow through are provided at each side of the substantially rectangular shape. This makes it possible to more easily degas the inside of the battery device 10. In this case, the compression-bonding regions 11 are preferably provided in such a manner that the sum total of the widths of the compression-bonding regions 11 at each side of the substantially rectangular shape of the battery device 10 is less than the width of the non-compression-bonding region 12 at the corresponding side of the substantially rectangular shape of the battery device 10.

As illustrated in FIG. 9, the compression-bonding regions 11 may be provided at the four corners of the substantially rectangular shape of the battery device 10 and in the middle of the longer sides of the substantially rectangular shape of the battery device 10 in an island form. Specifically, the compression-bonding regions 11 may be provided at three separated points along each of the longer sides of the substantially rectangular shape of the battery device 10. It is thus possible to more firmly fix the positive electrode 20, the negative electrode 30, and the separator at six points in total in the battery device 10. Accordingly, it is possible to improve a handling property in fabricating the secondary battery 1. In this case, the compression-bonding regions 11 are preferably provided in such a manner that the sum total of the widths of the respective compression-bonding regions 11 at each side of the substantially rectangular shape of the battery device 10 is less than the width of the non-compression-bonding region 12 at the corresponding side of the substantially rectangular shape of the battery device 10.

In the battery device 10 of the secondary battery 1 according to an embodiment, the compression-bonding regions 11 are provided at least at two respective positions opposed to each other in the peripheral edge part of the substantially rectangular shape. In addition, the positive electrode 20, the negative electrode 30, and the separator are thermocompression-bonded to each other in such a manner that the compression-bonding regions 11 and the non-compression-bonding region 12 are present. Thus, in the secondary battery 1 according to an embodiment, it is possible to fix the positive electrode 20, the negative electrode 30, and the separator to each other and to secure a degassing path for gas to flow through from the inside of the battery device 10. This makes it possible to suppress generation of a void where no electrolytic solution is impregnated in the battery device 10. As a result, it is possible to suppress degradation of a battery characteristic of the secondary battery 1 according to an embodiment.

Next, a description is given of modifications of the secondary battery 1 described above according to an embodiment. The configuration of the secondary battery 1 is appropriately modifiable as described below. Note that any two or more of the following series of modifications may be combined with each other.

In an embodiment described above, the separator is a porous film. However, the separator may be a stacked film including a polymer compound layer.

Specifically, the separator may include a base layer that is the porous film described above and the polymer compound layer provided on one side or each of both sides of the base layer. The polymer compound layer includes a polymer compound that has superior physical strength and is electrochemically stable, such as polyvinylidene difluoride. Thus, it is possible to improve adherence of the separator to each of the positive electrode 20 and the negative electrode 30 and to thereby suppress displacement inside the battery device 10. Accordingly, it is possible to suppress occurrence of swelling of the secondary battery 1 even if, for example, a decomposition reaction of the electrolytic solution occurs.

Note that the base layer, the polymer compound layer, or both in the separator may each include particles. The particles may include one or more kinds of particles among, for example, inorganic particles and resin particles. It is thus possible to dissipate heat by means of the particles upon heat generation by the secondary battery 1. Accordingly, it is possible to improve heat resistance and safety of the secondary battery 1. Although not particularly limited, examples of the inorganic particles may include particles of: aluminum oxide (alumina), aluminum nitride, boehmite, silicon oxide (silica), titanium oxide (titania), magnesium oxide (magnesia), and zirconium oxide (zirconia).

Note that the separator that is the stacked film including the polymer compound layer can be fabricated by preparing a precursor solution including, for example, the polymer compound and an organic solvent and thereafter applying the precursor solution on one side or both sides of the base layer.

In a case where such a separator is used also, lithium is movable between the positive electrode 20 and the negative electrode 30, and similar effects of the secondary battery 1 are thus obtainable.

FIGS. 3 and 4 illustrate an example in which the positive electrode tab 22 and the positive electrode current collector 21 are integrally provided, and the negative electrode tab 32 and the negative electrode current collector 31 are integrally provided. However, the positive electrode tab 22 and the positive electrode current collector 21 may be provided as separated members and may be joined to each other by a welding method. Similarly, the negative electrode tab 32 and the negative electrode current collector 31 may be provided as separated members and may be joined to each other by a welding method. In such a case also, similar effects of the secondary battery 1 are obtainable.

In an embodiment described above, the battery device 10 has a device structure of the stacked type in which the positive electrode 20 having the sheet shape, the negative electrode 30 having the sheet shape, and the separator are stacked on each other. However, the device structure of the battery device 10 is not limited to that in an embodiment described above. Specifically, the device structure of the battery device 10 may be of a zigzag folded type in which the positive electrode 20, the negative electrode 30, and the separator are folded in a zigzag manner, or of a stack-and-folding type.

Applications (application examples) of the secondary battery 1 are not particularly limited. The secondary battery 1 used as a power source may be used as a main power source or an auxiliary power source of, for example, electronic equipment and electric vehicles. The main power source is preferentially used regardless of the presence of any other power source. The auxiliary power source is used in place of the main power source, or is switched from the main power source.

Specific examples of the applications of the secondary battery 1 include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home or industrial battery systems for accumulation of electric power for a situation such as emergency. In such applications, a single secondary battery 1 may be used or multiple secondary batteries 1 may be used.

The battery pack may include a single battery, or may include an assembled battery. The electric vehicle is a vehicle that operates (travels) using the secondary battery 1 as a driving power source, and may be a hybrid automobile that is additionally provided with a driving source other than the secondary battery 1. An electric power storage system for home use is able to utilize electric power accumulated in the secondary battery 1 which is an electric power storage source to cause, for example, home appliances to operate.

An application example of the secondary battery 1 will now be described in further detail. The configuration of the application example described below is merely an example, and is appropriately modifiable.

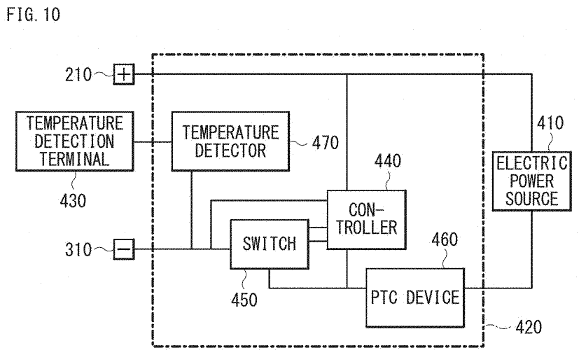

FIG. 10 illustrates a block configuration of a battery pack. The battery pack described here is a battery pack (a so-called soft pack) including one secondary battery 1, and is to be mounted on, for example, electronic equipment typified by a smartphone.

As illustrated in FIG. 10, the battery pack includes an electric power source 410 and a circuit board 420. The circuit board 420 is coupled to the electric power source 410, and includes a positive electrode terminal 210, a negative electrode terminal 310, and a temperature detection terminal 430.

The electric power source 410 includes one secondary battery 1. The secondary battery 1 has a positive electrode lead coupled to the positive electrode terminal 210 and a negative electrode lead coupled to the negative electrode terminal 310. The electric power source 410 is couplable to outside via the positive electrode terminal 210 and the negative electrode terminal 310, and is thus chargeable and dischargeable via the positive electrode terminal 210 and the negative electrode terminal 310. The circuit board 420 includes a controller 440, a switch 450, a PTC device 460, and a temperature detector 470. However, the PTC device 460 may be omitted.

The controller 440 includes, for example, a central processing unit (CPU) and a memory, and controls an overall operation of the battery pack. The controller 440 detects and controls a use state of the electric power source 410 on an as-needed basis.

If a voltage of the electric power source 410 (the secondary battery 1) reaches an overcharge detection voltage or an over discharge detection voltage, the controller 440 turns off the switch 450. This makes it possible to prevent a charging current from flowing into a current path of the electric power source 410. The overcharge detection voltage and the over discharge detection voltage are not particularly limited. For example, the overcharge detection voltage is 4.2 V±0.05 V and the over discharge detection voltage is 2.4 V±0.1 V.

The switch 450 includes, for example, a charge control switch, a discharge control switch, a charging diode, and a discharging diode. The switch 450 performs switching between coupling and decoupling between the electric power source 410 and external equipment in accordance with an instruction from the controller 440. The switch 450 includes, for example, a metal-oxide-semiconductor field-effect transistor (MOSFET). The charging and discharging currents are detected on the basis of an ON-resistance of the switch 450.

The temperature detector 470 includes a temperature detection device such as a thermistor. The temperature detector 470 measures a temperature of the electric power source 410 using the temperature detection terminal 430, and outputs a result of the temperature measurement to the controller 440. The result of the temperature measurement to be obtained by the temperature detector 470 is used, for example, in a case where the controller 440 performs charge/discharge control of the electric power source 410 upon abnormal heat generation or in a case where the controller 440 performs a correction process regarding a remaining capacity of the electric power source 410 upon calculating the remaining capacity.

### EXAMPLES

Referring to Examples, a description is given in more detail below of the secondary battery and the method of manufacturing a secondary battery according to an embodiment. Note that Examples described below are merely examples for describing enablement and effects of the secondary battery and the method of manufacturing a secondary battery according to an embodiment. The present technology is therefore not limited to Examples described below.

Secondary batteries of the stacked type according to an embodiment were each fabricated by the following procedure.

First, the positive electrode active material, the positive electrode binder, and the positive electrode conductor were mixed with each other to thereby obtain a positive electrode mixture. Thereafter, the positive electrode mixture was put into an organic solvent to thereby prepare a paste positive electrode mixture slurry. The prepared positive electrode mixture slurry was applied on both sides of the positive electrode current collector (an aluminum foil), following which the applied positive electrode mixture slurry was heated and dried to thereby form the positive electrode active material layers. Thereafter, the positive electrode active material layers were compression-molded by means of a roll pressing machine. The positive electrode was thus fabricated.

Thereafter, the negative electrode active material, the negative electrode binder, and the negative electrode conductor were mixed with each other to thereby obtain a negative electrode mixture. Thereafter, the negative electrode mixture was put into an organic solvent to thereby prepare a paste negative electrode mixture slurry. The prepared negative electrode mixture slurry was applied on both sides of the negative electrode current collector (a copper foil), following which the applied negative electrode mixture slurry was heated and dried to thereby form the negative electrode active material layers. Thereafter, the negative electrode active material layers were compression-molded by means of a roll pressing machine. The negative electrode was thus fabricated.

Thereafter, the electrolyte salt was put into a solvent and the electrolyte salt was dissolved in the solvent. The electrolytic solution was thus prepared.

Thereafter, the positive electrode, the negative electrode, and the separator were stacked on each other and the stacked positive electrode, negative electrode, and separator were fixed to each other by thermocompression-bonding. Thereafter, the stack of the positive electrode, the negative electrode, and the separator was placed inside the outer package member having the pouch-shaped structure, and the electrolytic solution was injected into the outer package member.

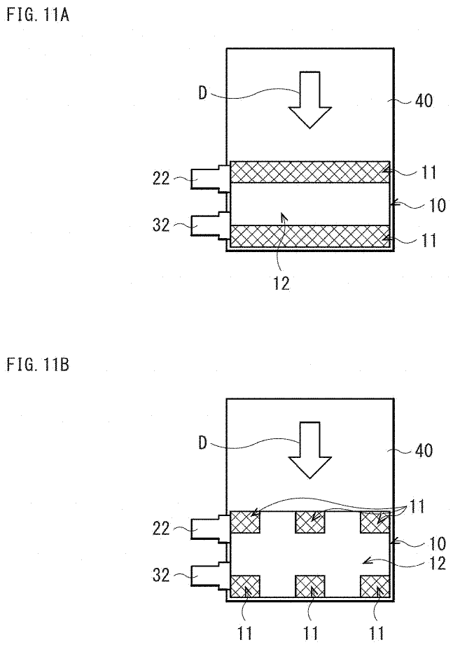

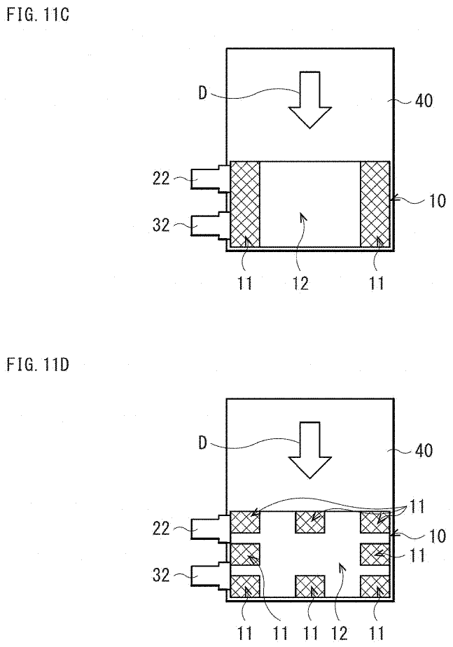

In Examples 1 to 7, the compression-bonding regions were provided in different regions of the substantially rectangular shape of the battery device, and the positive electrode, the negative electrode, and the separator were thermocompression-bonded to each other. Specifically, in Example 1, the compression-bonding regions were provided to extend along the two respective longer sides of the substantially rectangular shape of the battery device, as illustrated in FIG. 11A. In Examples 2 and 3, the compression-bonding regions were provided at six separated points in total that were located along the two longer sides of the substantially rectangular shape of the battery device, as illustrated in FIG. 11B. In Examples 4, 6, and 7, the compression-bonding regions were provided to extend along the two respective shorter sides of the substantially rectangular shape of the battery device, as illustrated in FIG. 11C. In Example 5, the compression-bonding regions were provided at eight points, i.e., in the middle of each side and at four corners of the substantially rectangular shape of the battery device, as illustrated in FIG. 11D. In FIGS. 11A to 11D, the lateral side D, from which degassing was to be performed, corresponds to the longer side of the substantially rectangular shape of the battery device.

Thereafter, the inside of the battery device and the inside of the outer package member were degassed in a vacuum and reduced pressure environment, following which thermocompression-bonding was performed on a portion of the outer package member around the entire battery device to seal the battery device in the outer package member. The secondary battery was thus fabricated. Note that the fabrication of the secondary battery caused no defect related to displacement of the positive electrode, the negative electrode, and the separator.

Regarding the fabricated secondary battery, after the elapse of a sufficient period of time to impregnate the battery device with the electrolytic solution, it was evaluated with use of an ultrasonic inspection apparatus manufactured by Japan Probe Co., Ltd. whether a void was present in the battery device. The ultrasonic inspection apparatus is able to determine presence or absence and a size of a void in the battery device on the basis of reflection of ultrasonic waves on an interface of, for example, a void.

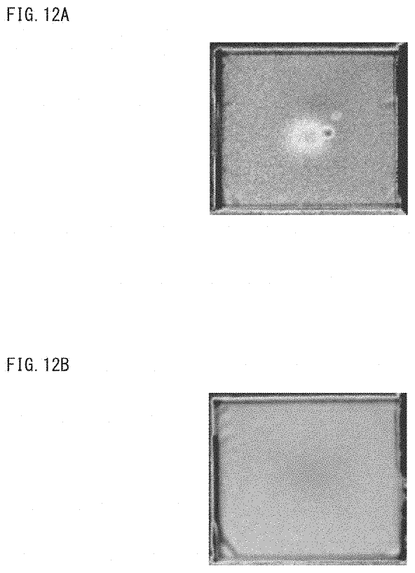

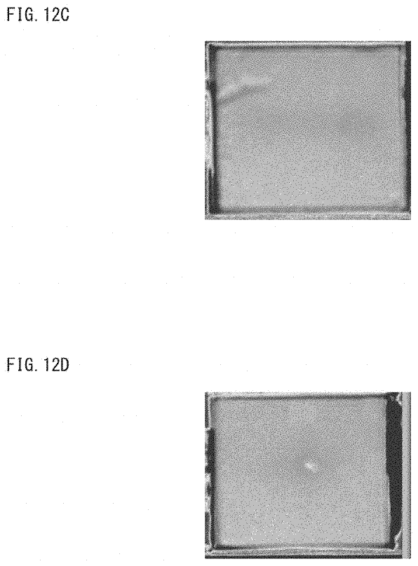

FIGS. 12A to 12D each illustrate an example of a heatmap representing a result obtained by scanning the entire battery device of the secondary battery of corresponding one or ones of Examples 1 to 5 with use of the ultrasonic inspection apparatus. In FIG. 12A corresponding to Example 1, a void in the battery device was observed as a white point having high brightness. In FIG. 12B corresponding to Examples 2 and 3, no void was observed in the battery device. In FIG. 12C corresponding to Example 4, no void was observed in the battery device. In FIG. 12D corresponding to Example 5, no void was observed in the battery device.

In addition, a region in which an attenuation rate of ultrasonic waves was at or above a threshold was determined as a void, and a void rate was calculated by dividing the area of the determined void by the area of the entire battery device. Table 1 below describes the calculated void rate and a proportion of the non-compression-bonding region at each side of the battery device (i.e., a proportion of the non-compression-bonding region to the entire side).

TABLE 1

| | | Proportion | Proportion | |
|---|---|---|---|---|
| | | (%) of non- | (%) of non- | |
| | | compression- | compression- | |
| | Positions to provide | bonding region | bonding region | Void rate |
| | compression-bonding regions | on longer side | on shorter side | (%) |
| Example 1 | Extend along two longer sides | 0 | 67.0 | 1.4 |
| Example 2 | At six separated points | 57.1 | 67.0 | 0 |
| | located along two longer sides | | | |
| Example 3 | At six separated points | 57.1 | 47.4 | 0 |
| | located along two longer sides | | | |
| Example 4 | Extend along two shorter sides | 71.2 | 0 | 0 |
| Example 5 | At eight points including middle | 57.1 | 47.4 | 0 |
| | of each side and four corners | | | |
| Example 6 | Extend along two shorter sides | 35.0 | 0 | 0 |
| Example 7 | Extend along two shorter sides | 33.0 | 0 | 9 |

Based upon Table 1, in the secondary batteries of Examples 1 and 7, the void rate was extremely low. In the secondary batteries of Examples 2 to 6, no void was present. In the secondary batteries of Examples 1 to 7, the compression-bonding regions were provided at respective positions opposed to each other in the peripheral edge part of the substantially rectangular shape of the battery device, and the non-compression-bonding region in which the positive electrode, the negative electrode, and the separator were not thermocompression-bonded was present. Accordingly, in the secondary batteries of Examples 1 to 7, it was possible to perform sufficient degassing.

In the secondary batteries of Examples 2 to 6, the degassing was performed more sufficiently as compared with the secondary battery of Example 1. Accordingly, it is seen that if the non-compression-bonding region is present on the longer side that is the lateral side from which the degassing is to be performed, it is possible to perform sufficient degassing on the secondary battery. In addition, it is seen that more sufficient degassing was achievable with the secondary batteries of Examples 4 and 6 in which the proportion of the non-compression-bonding region on the longer side, i.e., the lateral side from which the degassing was to be performed, was 35% or greater (i.e., in other words, the proportion of the compression-bonding region was 65% or less), as compared with the secondary battery of Example 7.

Although the present technology has been described above with reference to one or more embodiments including Examples, the configuration of the present technology is not limited to the description herein, and is therefore modifiable in a variety of suitable ways.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member having flexibility; and
a battery device having an elongated shape, the battery device being contained inside the outer package member, wherein
the battery device includes a positive electrode and a negative electrode that are stacked on each other in a thickness direction of the battery device, with a separator interposed between the positive electrode and the negative electrode, the positive electrode and the negative electrode each being a sheet having a substantially rectangular shape,
the battery device includes compression-bonding regions and a non-compression-bonding region other than the compression-bonding regions, and
the positive electrode, the negative electrode, and the separator are compression-bonded to each other in the compression-bonding regions that are provided at least at two respective positions opposed to each other in a peripheral edge part of the substantially rectangular shape.

2. The secondary battery according to claim 1, wherein the compression-bonding regions each have a compression-bonding mark that is depressed in the thickness direction of the battery device.

3. The secondary battery according to claim 1, wherein a total length of the compression-bonding regions at a side of the substantially rectangular shape is less than a length of the non-compression-bonding region at the side.

4. The secondary battery according to claim 1, wherein a length of the compression-bonding regions at a side of the substantially rectangular shape is less than or equal to 65 percent of a length of the side.

5. The secondary battery according to claim 1, wherein the compression-bonding regions are provided at least at four respective corners of the substantially rectangular shape.

6. The secondary battery according to claim 1, wherein the compression-bonding regions are provided at least at three respective separated points along at least one longer side of the substantially rectangular shape.

7. The secondary battery according to claim 1, wherein
the outer package member is sealed by a sealing part provided at an outer periphery, and
one side of the sealing part includes an electrolytic solution injected into the outer package member.

8. The secondary battery according to claim 7, wherein the compression-bonding regions are provided in an island form to allow the non-compression-bonding region to be present, at a side of the substantially rectangular shape that is opposed to the sealing part including the electrolytic solution.

9. The secondary battery according to claim 1, wherein the secondary battery comprises a lithium-ion secondary battery.

10. A method of manufacturing a secondary battery, the method comprising:
forming a battery device having an elongated shape, by stacking a positive electrode and a negative electrode on each other with a separator interposed therebetween, the positive electrode and the negative electrode each being a sheet having a substantially rectangular shape;
compression-bonding the positive electrode, the negative electrode, and the separator to each other in compression-bonding regions to thereby allow the battery device to include the compression-bonding regions and a non-compression-bonding region other than the compression-bonding regions, the compression-bonding regions being provided at least at two respective positions opposed to each other in a peripheral edge part of the substantially rectangular shape of the battery device;
placing the battery device inside an outer package member and partly sealing the outer package member to leave an opening to thereby provide the outer package member with a pouch shape, the outer package member having flexibility;
injecting an electrolytic solution into the outer package member through the opening; and
sealing the opening.
